(19) United States
(12) Patent Application Publication
(10) Pub. No.: US 2015/0338672 A1
(43) Pub. Date: Nov. 26, 2015

(54) STEREOSCOPIC IMAGE DISPLAYER

(71) Applicant: C VISION TECHNOLOGY CO., LTD., Shenzhen (CN)

(72) Inventors: TSUNG-YAU FANG, TAO YUN (TW); CHING-TE SHIH, KAOHSIUNG CITY (TW)

(21) Appl. No.: 14/505,648

(22) Filed: Oct. 3, 2014

(30) Foreign Application Priority Data
May 23, 2014 (TW) 103118137

(51) Int. Cl. G02B 27/22; G02F 1/1333; G02F 1/1335; G06F 3/041

(52) U.S. Cl. CPC G02B 27/2228; G06F 3/041; G02F 1/13338; G02F 1/1336

(57) ABSTRACT

The instant disclosure provides a stereoscopic image displayer including a backlight module, a LCD module, a stereoscopic film, and a touch panel. The LCD module is disposed on the backlight module. The stereoscopic film is disposed on the LCD module by an optical adhesive. The stereoscopic film includes a plastic film and a three-dimensional raster. The three-dimensional raster is disposed on the plastic film. The plastic film has a thickness range from 0.015 mm to 0.25 mm. The touch panel is disposed on the stereoscopic film forming an air layer therebetween.

### BACKGROUND OF THE INVENTION

1. Field of the Invention

The instant disclosure relates to a stereoscopic image display; in particular, to a stereoscopic image display having a thin stereoscopic film.

2. Description of Related Art

Three-dimensional (3D) display technology through stereoscopic imaging has rapidly developed and is progressively becoming a daily part of our technological lives. Typically, a distance between a human's left and right eye is about 6.5 cm, which leads to the occurrence of binocular parallax or disparity, the horizontal difference in images seen by the left and right eyes. 3D stereoscopic image display takes advantage of this disparity and designs left-eye only and right-eye only images respectively viewable only by the left and right eyes.

In order to diversify the application and provide more realistic 3D stereoscopic imaging, the emphasis on 3D imaging has been mainly focused on naked eye 3D imaging devices or the lack of any special tools or glasses to view 3D stereoscopic images. Naked eye 3D image display devices mainly depend on the optical technologies such as “lenticular lens” and “the parallax barrier”. The basic theory behind the “lenticular lens” mainly relies on the refraction of a convex lens, simultaneously splitting and projecting an image into both the left and the right eyes to achieve 3D effects, whereas the “parallax barrier” relies on the theory of light propagation in order to project multiple perspective images through an array of fine slits, parallax barrier, and then into the human eyes to generate stereoscopic vision.

However, many of the conventional naked eye 3D display devices use glass materials as the base substrate of a stereoscopic film within the 3D display device. Glass materials lead to end products which have a certain structural thickness (approximately between 0.5 to 0.3 mm) that does not satisfy the existing demand of slim and light electronic products.

Besides, by applying glass materials as the base substrate of the 3D display device for mobile devices or tablet types of end products, the overall structural thickness of the 3D display devices is most likely affected such as modification of the casing's tooling, thus increasing production costs and affecting the completion time of product development and design.

To address the above issues, the inventor strives via associated experience and research to present the instant disclosure, which can effectively improve the limitation described above.

### SUMMARY OF THE INVENTION

The object of the instant disclosure is to provide a stereoscopic image display that has a thin overall thickness by using a thin film type of stereoscopic film and can be directly applied into exiting mobile phone and tablet type of end products without having to modify tooling for exterior casings while reducing production costs.

In order to achieve the aforementioned objects, according to an embodiment of the instant disclosure, a stereoscopic image display is provided. The stereoscopic image display includes a backlight module, a LCD module, a stereoscopic film, and a touch panel. The LCD module is disposed on the backlight module. The stereoscopic film is disposed on the LCD module by an optical adhesive. The stereoscopic film includes a plastic film and a three-dimensional raster. The three-dimensional raster is disposed on the plastic film. The plastic film has a thickness ranges from 0.015 mm to 0.25 mm. The touch panel is arranged above the stereoscopic film forming an air layer therebetween.

Another embodiment of the instant disclosure provides a stereoscopic image display. The stereoscopic image display includes a backlight module, a LCD module, a stereoscopic film, and a touch panel. The LCD module is disposed on the backlight module. The stereoscopic film is disposed on the LCD module by a first optical adhesive. The stereoscopic film includes a plastic film and a three-dimensional raster. The three-dimensional raster is disposed on the plastic film. The plastic film has a thickness ranges from 0.015 mm to 0.25 mm. The touch panel is disposed on the three-dimensional raster of the stereoscopic film by a second optical adhesive.

The instant disclosure provides embodiments which reduce the overall thickness of the stereoscopic image display by using a thin film type of stereoscopic film and can be directly applied into existing mobile phone and tablet type of end products without having to modify tooling for exterior casings, while reducing production costs.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is an exploded view of a stereoscopic image display in accordance with a first embodiment of the instant disclosure;

FIG. 2 is an assembled view of the stereoscopic image display in accordance with the first embodiment of the instant disclosure;

FIG. 3 is another assembled view of the stereoscopic image display in accordance with the first embodiment of the instant disclosure;

FIG. 4 is an exploded view of the stereoscopic image display in accordance with a second embodiment of the instant disclosure;

FIG. 5 is an assembled view of the stereoscopic image display in accordance with the second embodiment of the instant disclosure; and

FIG. 6 is another assembled view of the stereoscopic image display in accordance with the second embodiment of the instant disclosure.

### DETAILED DESCRIPTION OF THE PREFERRED EMBODIMENTS

The aforementioned illustrations and detailed descriptions are exemplary for the purpose of further explaining the scope of the instant disclosure. Other objectives and advantages related to the instant disclosure will be illustrated in the subsequent descriptions and appended drawings.

### First Embodiment

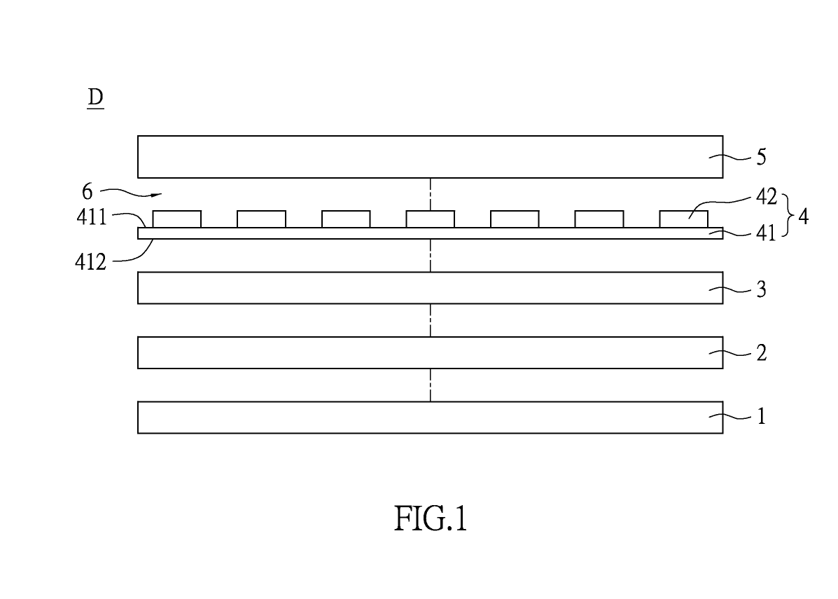

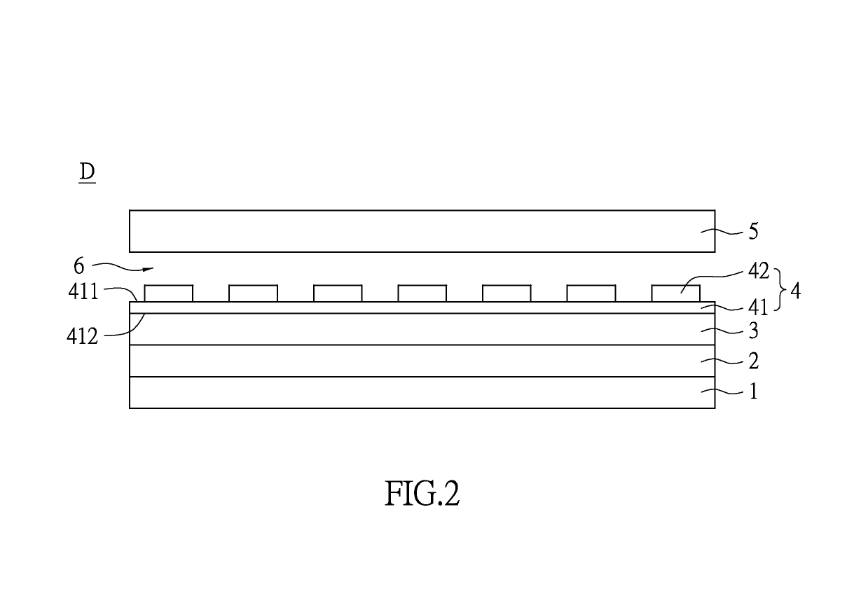

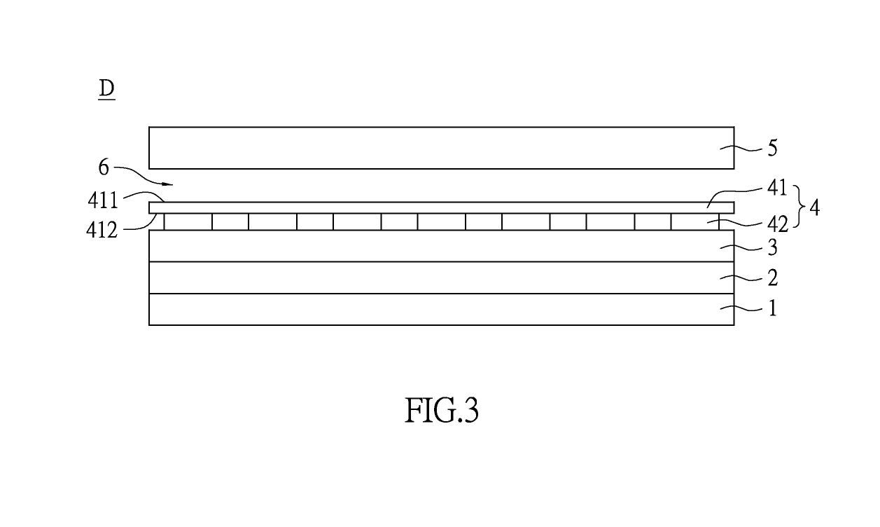

Please refer to FIGS. 1 to 3. FIG. 1 is an exploded view of a stereoscopic image display in accordance with a first embodiment of the instant disclosure. FIG. 2 is an assembled view of the stereoscopic image display in accordance with the first embodiment of the instant disclosure. FIG. 3 is another assembled view of the stereoscopic image display in accordance with the first embodiment of the instant disclosure. The first embodiment to the instant disclosure provides a stereoscopic image display D which includes a backlight module 1, a liquid crystal display module 2, a stereoscopic film 4, and a touch panel 5 (such as touch ITO transparent conductive film). The liquid crystal display module 2 is disposed on the backlight module 1, the stereoscopic film is disposed on the liquid crystal display module 2 via an optical adhesive 3. The liquid crystal display module 2 usually requires the backlight module 1 to provide sufficient brightness and uniform light distribution in order to display images since the liquid crystal display module 2 typically does not emit light itself. Thus, light provided by the backlight module 1 passes through the stereoscopic film 4 and projects images displayed on the liquid crystal display module 2. By properly positioning the stereoscopic film 4 to the stereoscopic display module D, a three-dimensional imaging display is provided, while touch panel 5 provides touch control for the stereoscopic display module D. The touch panel 5 can be a capacitive, resistive, optical, or acoustic touch panel.

Please refer to FIG. 1. The stereoscopic film 4 is disposed on the liquid crystal display module 2 through an optical adhesive 3. The optical adhesive 3 can be made of optically clear resin (OCR), liquid optically clear adhesive (LOCA), optically clear adhesive (OCA), or similar types of optical adhesives 3 having light transmissive properties. The optical adhesive 3 has a thickness range from 0.01 mm to 0.3 mm with a preferable range from 0.15 to 0.22 mm. In other words, the optical adhesive 3 not only provides attachment between the stereoscopic film 4 and the liquid crystal display module 2, the optical adhesive 3 also provides adjustments to optical focusing, refractive index, and curvature via parameter adjustments such as thickness, materials, etc, in order to provide the most preferred three-dimensional effects through the stereoscopic film 4.

Moreover, the stereoscopic film 4 has a plastic film 41 and a three-dimensional raster 42. The three-dimensional raster 42 is disposed on the plastic film 41. The three-dimensional raster 42 can be disposed on a top surface 411 of the plastic film 41 as shown in FIG. 2 or on a bottom surface 412 of the plastic film 41 as shown in FIG. 3 to adjust curvature and focal length. The plastic film 41 has a thickness ranges from 0.015 mm and 0.25 mm. The plastic film 41 can be made of high polymer materials such as the high light transmittance polyethylene terephthalate (PET), polyethylene (PE), or polyvinyl chloride (PVC) as the base substrate. High light transmittance can range from 85% to 95%, while the refractive index can range from 1.45 to 1.6. The three-dimensional raster 42 can be disposed on the plastic film 41 via typographic, printing, or semi-conductive processes. For example printing or typographical process can continuously or single-sheet print the three-dimensional raster 42 onto the plastic film 41 at 200 dpi, or high precision printing at 1200 dpi to 2400 dpi. Alternatively, the pattern of the three-dimensional raster 42 can be formed directly onto the plastic film 41 through lithography methods.

Furthermore, the touch panel 5 can be arranged above the stereoscopic film 4 to form an air layer 6 therebetween. In the instant embodiment, a frame (not shown) surrounding the stereoscopic image display module D can provide a predetermined distance between the touch panel 5 and the stereoscopic film 4 to accommodate the air layer 6.

The overall thickness of the stereoscopic image display D can be reduced through the thin-film types of plastic film 41 and three-dimensional raster 42 in the stereoscopic film 4, thus the stereoscopic image display D can be directly applied to existing mobile phone or tablet type of end products without having to modify tooling for cases and reducing production costs at the same time.

### Second Embodiment

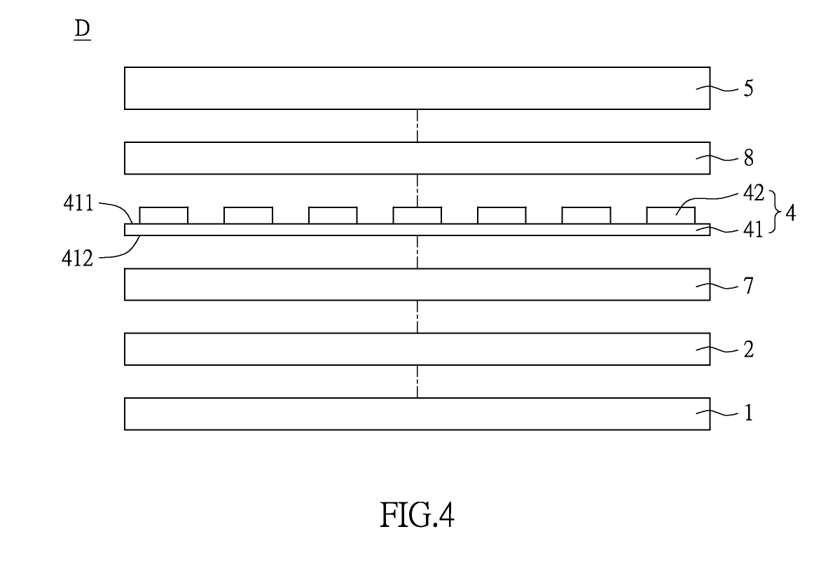

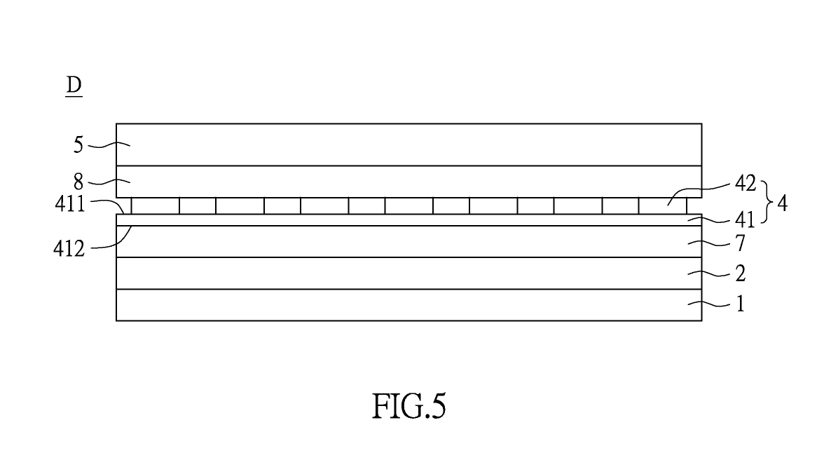

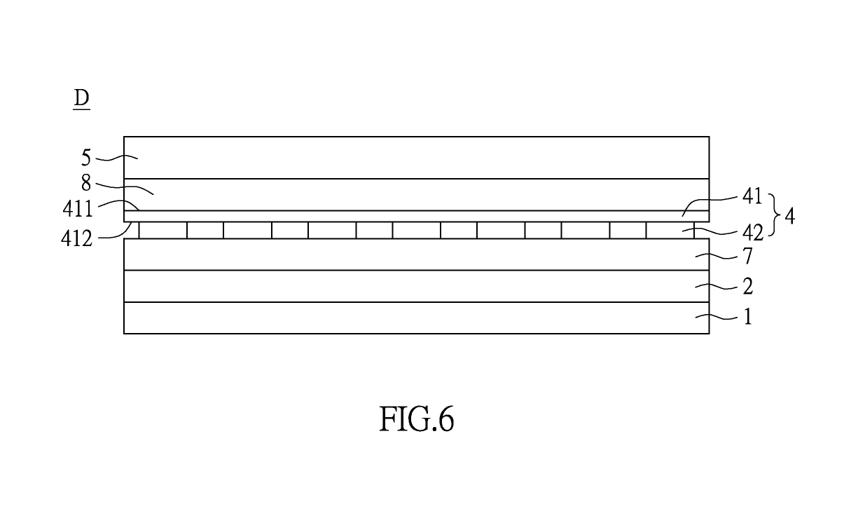

Please refer to FIGS. 4 to 6. FIG. 4 is an exploded view of the stereoscopic image display in accordance with a second embodiment of the instant disclosure. FIG. 5 is an assembled view of the stereoscopic image display in accordance with the second embodiment of the instant disclosure. FIG. 6 is another assembled view of the stereoscopic image display in accordance with the second embodiment of the instant disclosure. The second embodiment of the instant disclosure provides a stereoscopic image display D which includes a backlight module 1, a liquid crystal display module 2, a stereoscopic film 4, and a touch panel 5. As shown in FIGS. 2 and 4, the second embodiment and the first embodiment mainly differs in that the touch panel 5 in the second embodiment is disposed on the three-dimensional raster 42 of the stereoscopic film 4 via a second optical adhesive 8.

Please refer to FIG. 4. The liquid crystal display module 2 is disposed on the backlight module 1. The stereoscopic film 4 is disposed on the liquid crystal display module 2 through a first optical adhesive 7. The liquid crystal display module 2 usually requires the backlight module 1 to provide sufficient brightness and uniform light distribution in order to display images since the liquid crystal display module 2 typically does not emit light itself. Thus, light provided by the backlight module 1 passes through the stereoscopic film 4 and projects images displayed on the liquid crystal display module 2. By properly arranging the stereoscopic film 4 with respect to the stereoscopic display module D, three-dimensional imaging display is provided, while a touch panel 5 provides touch control for the stereoscopic display module D.

Moreover, please refer to FIGS. 5 and 6. The stereoscopic film 4 of the second embodiment has a plastic film 41 and a three-dimensional raster 42. The three-dimensional raster 42 is disposed on the plastic film 41. The plastic film 41 has a thickness range from 0.015 mm and 0.25 mm. The three-dimensional raster 42 can be disposed on a top surface 411 of the plastic film 41 as shown in FIG. 5 or on a bottom surface 412 of the plastic film 41 as shown in FIG. 6 to adjust curvature and focal length. Notably, the plastic film 41 can be made of high polymer materials such as the high light transmittance polyethylene terephthalate (PET), polyethylene (PE), or polyvinyl chloride (PVC) as the base substrate. High light transmittance can range from 85% to 95%, while the refractive index can range from 1.45 to 1.6. The three-dimensional raster 42 can be disposed on the plastic film 41 via typographic, printing, or semi-conductive processes. For example printing or typographical process can continuously or single-sheet print the three-dimensional raster 42 onto the plastic film 41 at 200 dpi (dots per inch), or high precision printing at 1200 dpi to 2400 dpi. Alternatively, the pattern of the three-dimensional raster 42 can be formed directly onto the plastic film 41 through lithography methods.

Specifically, the stereoscopic film 4 is disposed on the three-dimensional raster 42 of the stereoscopic film 4 through a second optical adhesive 8 as shown in FIG. 4. The first and second optical adhesives 7, 8 can be made of optically clear resin (OCR), liquid optically clear adhesive (LOCA), optically clear adhesive (OCA), or similar types of optical adhesives 3 having light transmissive properties in the second embodiment. The first and second optical adhesives 7, 8 each have a thickness range from 0.01 mm to 0.3 mm with a preferable range from 0.15 to 0.22 mm. In other words, the first and second optical adhesives 7, 8 not only provide attachment between the stereoscopic film 4 and the liquid crystal display module 2, the first and second optical adhesives 7, 8 also provide adjustments to optical focusing, refractive index, and curvature via parameter adjustments such as thickness, materials, etc, in order to provide the most preferred three-dimensional effects through the stereoscopic film 4.

### Possible Effectiveness of the Embodiments

In summary, due to fact that the overall thickness of the stereoscopic image display D can be reduced through the use of thin-film types of plastic film 41 and three-dimensional raster 42 in the stereoscopic film 4, the stereoscopic image display D can be directly applied to existing mobile phone or tablet type of end products without having to modify tooling for cases and reducing production costs at the same time. Specifically, the optical adhesive 4, and the first and second optical adhesives 7, 8 provide adjustments to optical focusing, refractive index, and curvature via parameter adjustments such as thickness, materials, etc, in order to provide the most preferred three-dimensional effects through the stereoscopic film 4.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. A stereoscopic image display, comprising:
A backlight module;
a liquid crystal display module disposed on the backlight module;
a stereoscopic film disposed on the liquid crystal display module via an optical adhesive; wherein the stereoscopic film has a plastic film and a three-dimensional raster, the three-dimensional raster is disposed on the plastic film, and the plastic film has a thickness range from 0.015 mm to 0.25 mm; and
a touch panel arranged above the stereoscopic film, the stereoscopic film and the touch panel having an air layer therebetween.

2. The stereoscopic image display as recited in claim 1, wherein the optical adhesive has a thickness range from 0.01 mm to 0.3 mm.

3. The stereoscopic image display as recited in claim 1, wherein the three-dimensional raster is disposed on a top or bottom surface of the plastic film via typographic or semi-conductive processes.

4. The stereoscopic image display as recited in claim 1, wherein the plastic film is made of high polymer materials.

5. The stereoscopic image display as recited in claim 4, wherein the high polymer materials are one of the materials selected from polyethylene terephthalate, polyethylene, and polyvinyl chloride.

6. A stereoscopic image display, comprising:
A backlight module;
a liquid crystal display module disposed on the backlight module;
a stereoscopic film attached to the liquid crystal display module via an first optical adhesive; wherein the stereoscopic film has a plastic film and a three-dimensional raster, the three-dimensional raster is disposed on the plastic film, and the plastic film has a thickness range from 0.015 mm to 0.25 mm; and
a touch panel disposed on the three-dimensional raster of the stereoscopic film via a second optical adhesive.

7. The stereoscopic image display as recited in claim 6, wherein the first optical adhesive and the second optical adhesive each has a thickness range from 0.01 mm to 0.3 mm.

8. The stereoscopic image display as recited in claim 6, wherein the three-dimensional raster is disposed on a top or bottom surface of the plastic film via typographic or semi-conductive processes.

9. The stereoscopic image display as recited in claim 6, wherein the plastic film is made of high polymer materials.

10. The stereoscopic image display as recited in claim 9, wherein the high polymer materials are one of the materials selected from polyethylene terephthalate, polyethylene, and polyvinyl chloride.
